(19) United States
(12) Patent Application Publication
(10) Pub. No.: US 2026/0037152 A1
(43) Pub. Date: Feb. 5, 2026

(54) ROW-PRESS MITIGATION CIRCUIT DEVICE AND METHOD FOR SECURING DRAM AGAINST DATA-DISTURBANCE ERRORS

(71) Applicant: Georgia Tech Research Corporation, Atlanta, GA (US)

(72) Inventor: Moinuddin Qureshi, Atlanta, GA (US)

(21) Appl. No.: 19/287,127

(22) Filed: Jul. 31, 2025

Related U.S. Application Data
(60) Provisional application No. 63/677,755, filed on Jul. 31, 2024.

(51) Int. Cl. G06F 3/06

(52) U.S. Cl. CPC G06F 3/0619; G06F 3/0659; G06F 3/0673

(57) ABSTRACT

An exemplary device and method for detecting and mitigating data-disturbance errors in a DRAM array, including Row-Press exploits or phenomenon as well as Rowhammer exploits or phenomenon. By mitigating both types of disturbance errors, the exemplary device and method can comprehensively protect DRAM from various vulnerabilities and enhancing its reliability, and doing so, with minimal hardware overhead addition. The exemplary device and method can be integrated with circuitries employed for Row-Press and Rowhammer detection and correction. The exemplary device and method can employ a counter as a proxy to detect when a Rowhammer threshold is met. In some embodiments, the Row-Press detection circuit can trigger an increment (whole or fractional) to the Rowhammer counter.

### RELATED APPLICATION

This application claims priority to, and the benefit of, U.S. Provisional Patent Application No. 63/677,755, filed Jul. 31, 2024, entitled “SECURING DRAM AGAINST DATA-DISTURBANCE ERRORS VIA IMPLICIT ROW-PRESS MITIGATION,” which is incorporated by reference herein in its entirety.

### BACKGROUND

Dynamic Random-Access Memory (DRAM) is a storage technology used in computing systems (e.g., servers, embedded systems, etc.). DRAM cells are arranged in a grid of rows and columns, where each cell stores data as an electrical charge in a capacitor and requires periodic refreshing to maintain data integrity. DRAM technology has continued to scale down, reducing the size of individual cells and increasing the number of cells per chip. This scaling enables packing more memory into a smaller physical footprint, improving system performance and energy efficiency.

As DRAM scales to smaller technology nodes, the characteristics and interactions of memory cells become complex, which can be exploited by an attacker to compromise the memory security. Rowhammer is a computer security exploit or phenomenon that takes advantage of an unintended and undesirable side effect by unduly accessing dynamic random-access memory with a frequency that causes memory cells to electrically interact between themselves by leaking their charges, to possibly change the contents of nearby memory rows that were not addressed in the original memory access. Row-Press is another exploit or phenomenon that breaks memory isolation by keeping a DRAM row open for a period of time, which disturbs physically nearby rows enough to cause bitflips. These errors are typically not solvable using Error-Correcting Code (ECC).

There is a benefit to improving the system and method for improving the operation of DRAM.

### SUMMARY

An exemplary device and method are disclosed for detecting and mitigating data-disturbance errors in a DRAM array, including Row-Press (also referred to as implicit data-disturbance errors) exploits or phenomenon as well as Rowhammer exploits or phenomenon (also referred to as explicit data-disturbance errors). By mitigating both types of disturbance errors, the exemplary device and method can comprehensively protect DRAM from various vulnerabilities and enhancing its reliability, and doing so, with minimal hardware overhead addition. The exemplary device and method can be integrated with circuitries employed for Row-Press and Rowhammer detection and correction. The exemplary device and method can employ a counter as a proxy to detect when a Rowhammer threshold is met. In some embodiments, the Row-Press detection circuit can trigger an increment (whole or fractional) to the Rowhammer counter.

The exemplary system and method can track row access frequency and enforce periodic refresh operations, similar to current systems, and further adds the Row-Press monitoring without substantial redesign of the existing circuits. A straightforward approach would entail adjusting the threshold to prevent Rowhammer, but that approach could degrade performance operation as well as increase energy usage. To this end, the exemplary system and method can identify and neutralize disturbance conditions without need for redesign or frequent intervention in the DRAM array by adjusting the Rowhammer threshold. In addition, the exemplary system and method can mitigate risk of Row-Press and Rowhammer without placing a limit on row open time or reducing a Rowhammer threshold (TRH) of the array as solutions to Row-Press, doing so by using a defect tracker (e.g., memory-controller-based tracker, in-DRAM tracker) configured to detect a defective row caused by data-disturbance error for that or nearby row, increment an activation count of the defective row based on the data-disturbance error (e.g., Rowhammer (RH), Row-Press (RP)), and refresh adjacent rows when the activation count exceeds a threshold value.

In an aspect, a dynamic random-access memory (DRAM) device, configured with a data-disturbance error mitigation circuit (e.g., Rowhammer, Row Press) in a dynamic random-access memory (DRAM) array, is disclosed comprising: a plurality of memory rows in a plurality of banks; and a controller, operatively coupled to the DRAM array, configured to write, read, and refresh elements of the DRAM array, the controller being further configured to: count, via a circuit, activation count of each memory row or a subset of memory rows in the plurality of memory rows in a unit time for a given bank; increment activation count upon detecting, via the circuit, a defective memory row being opened for a pre-determined time period (e.g., tRC); and refresh an adjacent memory row upon the activation count being above a specified Rowhammer Threshold (TRH), wherein the activation count accounts for both Rowhammer and Row-press net effect to mitigate the defective memory row from repeated activation (Rowhammer) or leak charge on bit lines from being opened over time (Row-press).

In some embodiments, the circuit to detect the defective memory row being opened for a pre-determined time period is configured to: count, via a timer register, row open time from a starting time when a memory row is open to a stopping time when the memory row is closed over a fixed-length time window; and increment an integer value to the activation count upon the counted row open time being at least a pre-defined minimum time a row must be kept open.

In some embodiments, the controller includes a counter for each bank and a timer register for each row of the plurality of banks.

In some embodiments, the controller includes a counter for each bank and a timer register for a subset of rows of the plurality of banks.

In some embodiments, the circuit to identify the defective memory row is configured to: count, via a timer register, row open time from a starting time when a memory row is open to a stopping time when the memory row is closed over a fixed-length time window; and increment a fractional non-integer value to the activation count upon the counted row open time being at least a pre-defined minimum time a row must be kept open.

In some embodiments, the controller is a memory controller.

In some embodiments, the controller is an in-DRAM tracker digital logic circuit.

In some embodiments, the specified Rowhammer Threshold is established from a Rowhammer threshold scaled by a value for a given DDR device.

In some embodiments, the device described herein further comprises: an error correction code (ECC) circuit or a detection circuit configured to tolerate Rowhammer.

In another aspect, a system (computer system) is disclosed comprising: a dynamic random-access memory (DRAM) device configured with a data-disturbance error mitigation circuit (e.g., Rowhammer, Row Press) in a dynamic random-access memory (DRAM) array, the system comprising: a plurality of memory rows in a plurality of banks; and a controller, operatively coupled to the DRAM array, configured to write, read, and refresh elements of the DRAM array, the controller being further configured to: count, via a circuit, activation count of each memory row or a subset of memory rows in the plurality of memory rows in a unit time for a given bank; increment activation count upon detecting, via the circuit, a defective memory row being opened for a pre-determined time period (e.g., tRC); and refresh an adjacent memory row upon the activation count being above a specified Rowhammer Threshold (TRH), wherein the activation count accounts for both Rowhammer and Row-press net effect to mitigate the defective memory row from repeated activation (Rowhammer) or leak charge on bit lines from being opened over time (Row-press).

In some embodiments, the circuit to detect the memory row being opened for a pre-determined time period is configured to: count, via a timer register, row open time from a starting time when a memory row is open and stopped when the memory row is stopped over a fixed-length time window; and increment an integer value to the activation count upon the counted row open time being at least a pre-defined minimum time a row must be kept open.

In some embodiments, the controller includes a counter for each bank and a timer register for each row of the plurality of banks.

In some embodiments, the controller includes a counter for each bank and a timer register for a subset of rows of the plurality of banks.

In some embodiments, the circuit to identify the defective memory row is configured to: count, via a timer register, row open time from a starting time when a memory row is open to a stopping time when the memory row is closed over a fixed-length time window; and increment a fractional non-integer value to the activation count upon the counted row open time being at least a pre-defined minimum time a row must be kept open.

In some embodiments, the controller is a memory controller.

In some embodiments, the controller is an in-DRAM tracker digital logic circuit.

In yet another aspect, a dynamic random-access memory (DRAM) device, configured with a data-disturbance error mitigation circuit (e.g., Rowhammer, Row Press) in a dynamic random-access memory (DRAM) array, is disclosed comprising: a plurality of memory rows in a plurality of banks; and a controller, operatively coupled to the DRAM array, configured to write, read, and refresh elements of the DRAM array, the controller being further configured to: calculate, via a circuit, a probability value of a Rowhammer event in a memory row of a bank in the plurality of banks; count, via a timer register, row open time from a starting time when the memory row is open in the bank to a stopping time when the memory row is closed over a fixed-length time window in the bank; and recalculate the probability value of the Rowhammer event using an output of the timer register.

In some embodiments, the controller calculates the probability value of the Rowhammer event asp, and wherein the recalculated probability value is p(w+1), where w is the output of the timer register (e.g., a weight value of RP damage to the bank).

In some embodiments, the controller includes a timer register for each row of the plurality of banks.

In some embodiments, the controller includes a timer register for a subset of rows of the plurality of banks.

### BRIEF DESCRIPTION OF DRAWINGS

FIGS. 1A-1C each shows an exemplary device configured to detect and mitigate data-disturbance errors in a DRAM array using a Rowhammer mitigation circuit that further supports Row-Press mitigation, in accordance with an illustrative embodiment.

FIGS. 1D-1E each shows another exemplary device configured to detect and mitigate data-disturbance errors in a DRAM array using a Rowhammer mitigation circuit that supports Row-Press mitigation to provide higher-precision activation tracking via a fractional counter, in accordance with an illustrative embodiment.

FIGS. 2A-2B each shows another exemplary device configured to detect and mitigate data-disturbance errors in a DRAM array using a Rowhammer mitigation circuit that supports estimating a probability value of an occurrence of a Rowhammer or Row-Press, in accordance with an illustrative embodiment.

FIGS. 3A-3C show example operation flows of a defect tracker (e.g., in-DRAM tracker, memory-controller-based tracker), operatively coupled to a DRAM array, of the exemplary device, in accordance with an illustrative embodiment.

An experimental device was developed, and its two embodiments, referred to as ImPress-N and ImPress-P, were evaluated over a series of experiments.

FIGS. 4A-4B show example implementation of an integrated Rowhammer and Row-Press mitigation circuit, as described in relation FIGS. 1A-1C in the context of a study.

FIG. 4C shows example implementation for an integrated Rowhammer and Row-Press mitigation circuit, as described in relation FIGS. 1D-1E in the context of a study.

FIGS. 4D-4G show a unified charge-loss model employed in the study that relates Rowhammer and Row-Press to each other

FIGS. 5A-5D show the performances and overheads of an integrated Rowhammer and Row-Press mitigation circuit.

FIGS. 6A-6C show Rowhammer threshold (TRH) adjustments as solution to Rowhammer and Row-Press.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example Device

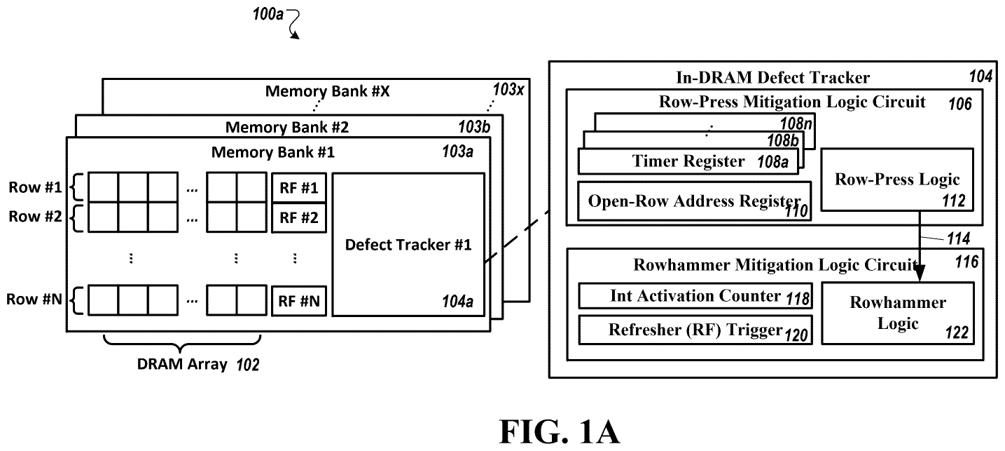

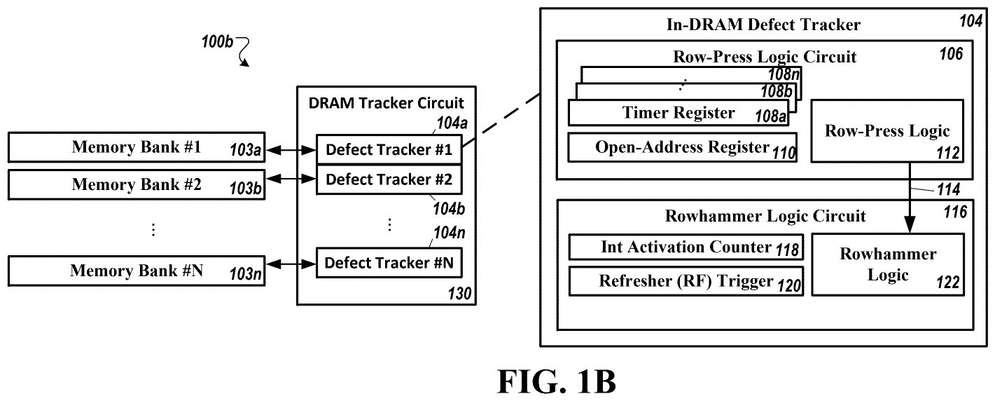

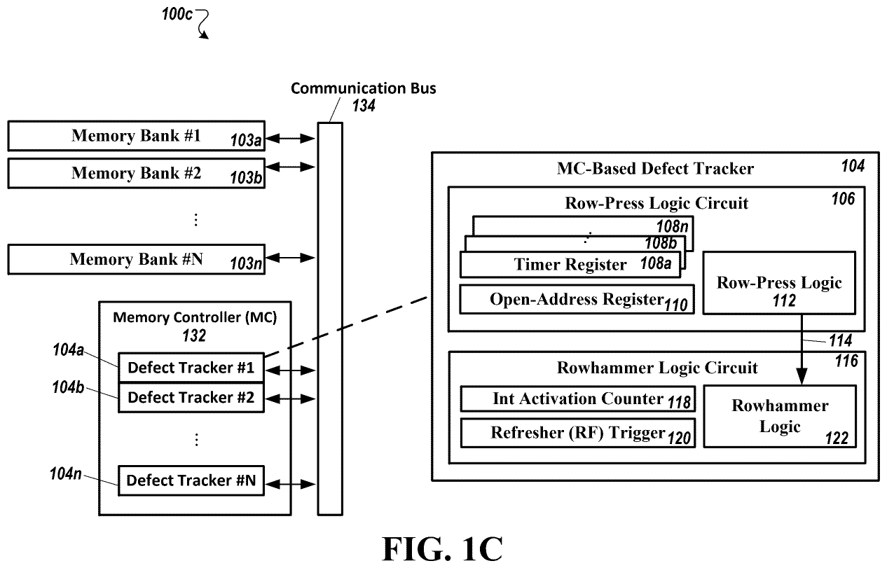

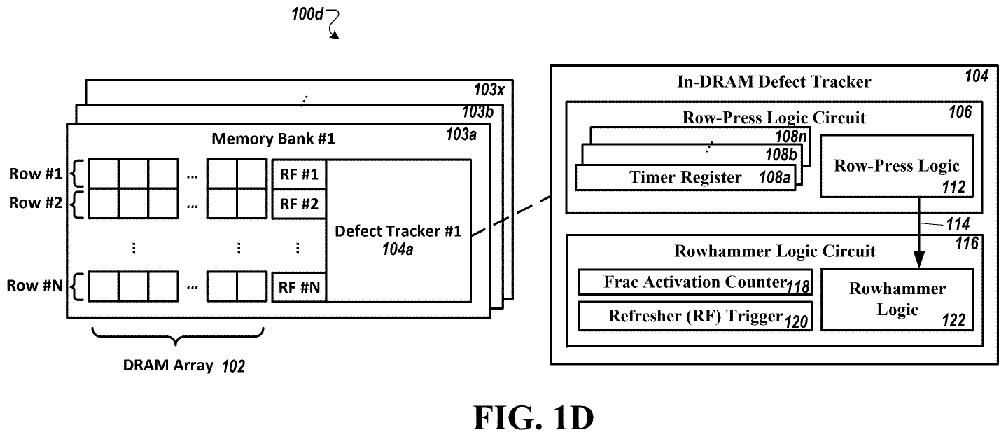

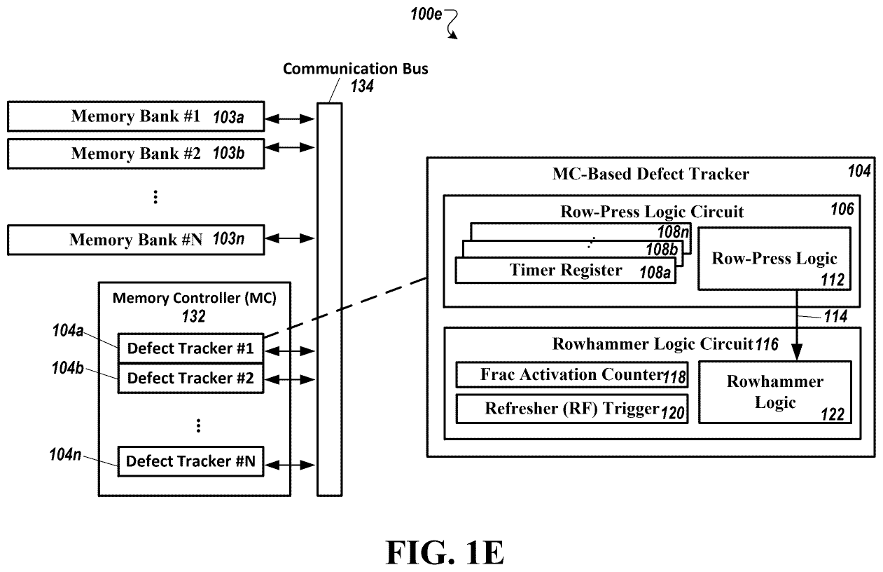

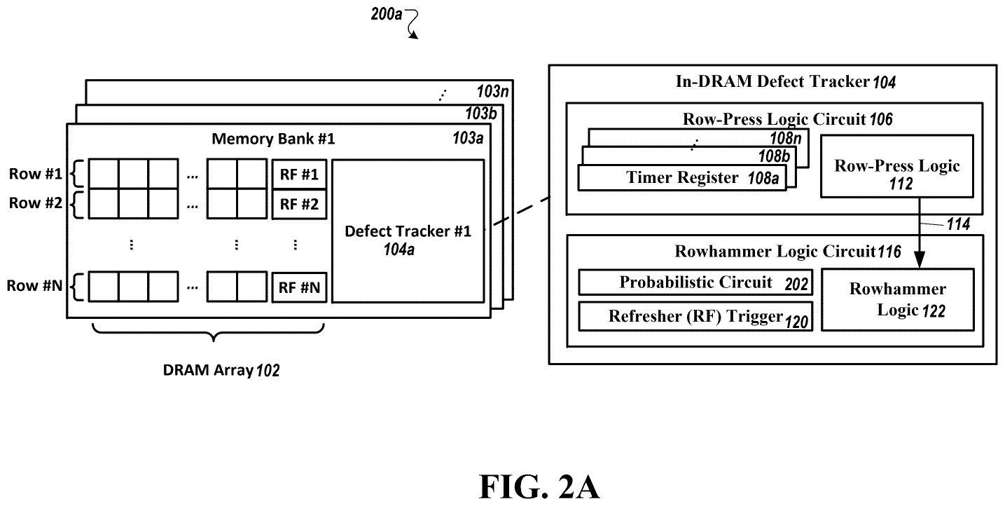

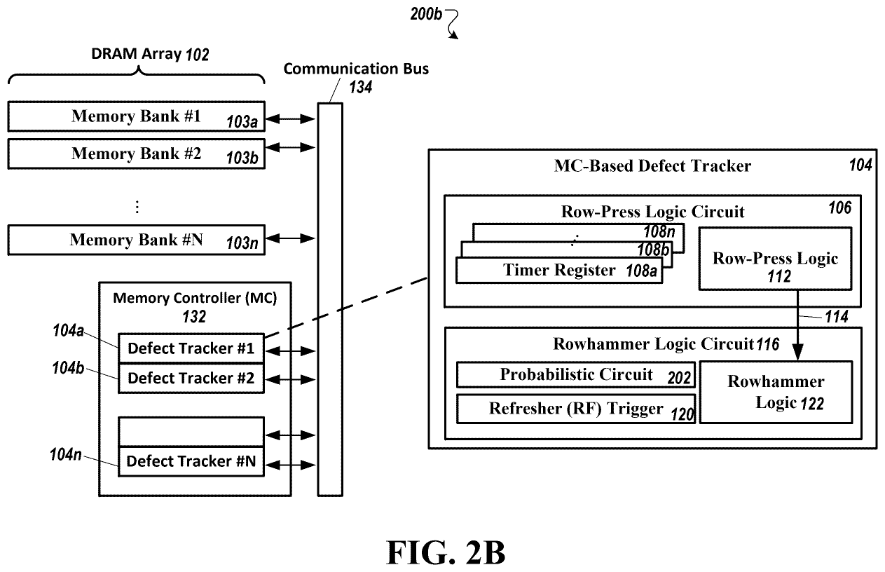

FIGS. 1A-1E each shows an example dynamic random-access memory (DRAM) device 100 (shown as DRAM 100a, DRAM 100b, DRAM-equipped computing device 100c, DRAM 100d, and DRAM-equipped computing device 100e-100e, DRAM 200a, and DRAM-equipped computing device 200b) with one or more counting-based data-disturbance error (DDE) mitigation circuits in accordance with an illustrative embodiment. FIGS. 2A-2B each shows an example dynamic random-access memory (DRAM) device 200 (shown as DRAM 200a, DRAM-equipped computing device 200b) with a probabilistic-based data-disturbance error (DDE) mitigation circuits in accordance with an illustrative embodiment.

In each of the FIGS. 1A-1E and FIGS. 2A-2B, the device or system (e.g., 100a-100e) is shown with a DRAM array or a memory bank having DRAM array, where each array has a plurality of rows and is configured with at least one defect tracker 104 configured to detect Row-Press conditions via a Row-Press and Row-Hammer mitigation logic circuit. The Row-Press logic circuit (e.g., 106) is preferably integrated into a Rowhammer mitigation logic circuit, though could be independently implemented when desired. The counter-based approach can be implemented per bank (e.g., FIG. 1A) of a DRAM with components to track Row-Press damage (as well as Row-Hammer damage) per row or some of the rows, which would leverage the existing architecture for today's DRAM. The Row-Press mitigation logic circuit is described in relation to 32 banks but can be employed in other memory topology in a similar manner having Rowhammer and Row-Press issues. A typical DRAM has 32 banks of DRAM array 102, in which a row in a bank is accessible at any instance in time. DRAM typically don‘t’ allow multiple rows to be accessed in a bank. The described Row-Press and Row-Hammer mitigation circuit can be implemented for other configurations of DRAM and other memory devices.

In FIGS. 1A, 1B, and 1D, a DRAM (e.g., 100a, 100b, 100d) is shown each configured with Row-Press mitigation logic circuit (shown also an “IN-DRAM defect tracker”) as well as Row-Hammer mitigation logic circuit as an in-DRAM configuration. FIGS. 1A and 1B show a first configuration configured to a baseline circuit (i.e., integer-based counting of damage by Row-Press). FIGS. 1D and 1E each show a second configuration configured with a more advanced implementation (fractional based counting of the damage by Row-Press). FIGS. 1C and 1E show a DRAM-equipped computing device (i.e., a computer device with a DRAM) each configured with a Row-Press mitigation logic circuit implemented in a memory controller as a memory-controller configuration, with the first baseline (FIG. 1C) and second more advanced configuration (FIG. 1E), respectively.

FIGS. 1A and 1D each show the Row-Press and Row-Hammer mitigation logic circuit implemented per bank. FIG. 1B shows the Row-Press and Row-Hammer mitigation logic circuit implemented per DRAM, where the defect detection per bank is centralized to a centralized location on the DRAM. FIGS. 1C and 1E each shows the Row-Press and Row-Hammer mitigation logic circuit implemented in a memory controller (e.g., on a motherboard or single board computer) to which the DRAM is operatively coupled, for each of the first baseline and second advanced configuration.

FIGS. 2A and 2B shows another configuration for Row-Press mitigation using the probabilistic approach. FIG. 2A shows an in-DRAM configuration. FIG. 2B shows a memory-controller-based configuration.

Baseline Integer-based Damage Tracker. FIGS. 1A, 1B, and 1C each show a baseline integer-based defect tracker. In each of FIGS. 1A, 1B, and 1C, the DRAM 100a includes a DRAM array 102 in a bank 103, and each array 102 includes memory cells arranged in rows (shown as rows #1 . . . row #N). FIG. 1A shows the tracker implemented per bank. FIG. 1B shows the tracker implemented per bank but aggregated into a single location on the DRAM. FIG. 1C shows the tracker implemented in the memory controller.

To access data from DRAM, a memory controller first issues an activation (ACT) to open a row. The row can continue to be open until the row is (i) proactively closed by the memory controller (e.g., closed-page policy), (ii) closed due to a row conflict to service data from another row, or (iii) closed to perform refresh. The defect tracker 104 for each bank is configured to (i) detect, via a Row-Press (RP) logic circuit 106 and a Rowhammer (RH) logic circuit 116, at least one expected defective memory row on the bank (due to improper frequent access of memory or improper keeping of memory row open) based on the time that the activation is issued and closed, and (ii) trigger corresponding refreshers (e.g., RF #1-RF #N) on the bank, after a condition (e.g., excision of activation counts of the defective row) is met (e.g., based on the RH logic circuit 116), to refresh adjacent rows of the defective row. The open-row time and closure are then used, as an indication of damage caused by Row-Press to update the Rowhammer activation counter. The Row-Press mitigation logic circuit thus integrates into the Rowhammer mitigation logic circuit without much design and with minimal overhead. FIG. 1B shows a single tracker circuit 130 for the DRAM, the tracker circuit 130 having multiple defect tracker 104a . . . 100n.

As shown in FIG. 1A, the Row-Press mitigation logic circuit 106 each is configured with a set of timer registers 108 (shown as 108a . . . 108n), an open-row address register 110, and a Row-Press logic 112. The Row-Press logic 112 is configured to (i) detect an Row-Press error (e.g., a row being activated/opened for a predetermined time period) on a row of a memory bank using a timer register 108 (e.g., 108a-108n) and an open-address register 110 on the RP logic circuit 106, and (ii) keep track of the number of activations (e.g., caused by RH or RP) using an integer activation counter 118 on the RH logic circuit 116 (to trigger refreshment of rows when a threshold number of activations is exceeded).

In FIGS. 1D-1E, each device 100d-100e (also referred to as precise Implicit Row-Press mitigation device (ImPress-P)) can (i) detect an RP error on a row of a memory bank using only the timer register 108 (e.g., 108a-108n) on the RP logic circuit 106, and (ii) keep track of the number of activations using a fractional integer activation counter 118 on the RH logic circuit 116.

In FIGS. 1A-1B, the defect tracker 104 can count, via an integer activation counter 118, the number of activations of a memory row (e.g., Row #1) of a memory bank (e.g., bank 103a) that the tracker 104 is a part of. While tracking the number of activations (e.g., of Row #1), the tracker 104 can detect, via an RP logic operation 112 of the RP logic circuit 106, if the memory row (e.g., Row #1) is defective for being activated/open for a predetermined time period (e.g., row-cycle time (tRC)), using a corresponding timer register (e.g., 108a), and the open-address register (ORA) 110. Specifically, defect detection, via the RP logic operation 112, includes (i) dividing the total DRAM operation time into fixed-length time windows, (ii) identifying, via the corresponding timer register (e.g., 108a), an ending time of every time window, and (iii) storing, in the ORA 110, a row address of the open row (e.g., Row #1) at an ending time. If the row address (of the open row (e.g., Row #1)) to store in the ORA 110 is identical to the row address stored in the ORA 110, then the RP logic operation 112 can (i) determine the open row (e.g., Row #1) as defective for being activated/open (e.g., from a starting time when the row is opened, to an ending time when the row is closed over the time window) for at least the predetermined time period, and (ii) send, to an RH logic operation 122 of the RH logic circuit 116, a signal 114 (e.g., request message) requesting an increment of the activation counts for the defective memory row (e.g., Row #1). The signal 114 can carry the activation/open time of the defective row (e.g., Row #1).

After receiving the signal 114, the RH logic operation 122 can determine an integer value (e.g., equivalent to the open time of the defective row), and the integer activation counter 118 can increment the activation count of the defective memory row (e.g., Row #1) by the determined integer value. The integer activation counter 118 can also increment the activation count by an integer value when the row (e.g., Row #1) is activated/opened naturally or by Rowhammer error (besides RP error). When the activation count for the defective memory row (e.g., Row #1) is above a specified Rowhammer Threshold (TRH), the defect tracker 104 can cause, via a refresher (RF) trigger module 120, corresponding refresher(s) (e.g., RF #2) on the respective memory bank (e.g., 103a) to refresh adjacent row(s) (e.g., Row #2) of the defective row (e.g., Row #1).

Higher-Precision Activation Tracking via Fractional Count Monitoring. In FIG. 1D, the defect detection, via the RP logic operation 112, allows for fractional precision adjustments to the RH circuit count. The RP logic operation 112 operates on a variable window for the open row time measurement. In some embodiments, the RP logic operation 112 is configured to (i) measure the open time (tON) of the open row (e.g., Row #1) (e.g., from a starting time when the row is opened, to an ending time when the row is closed) using only a corresponding timer register (e.g., 108a), (ii) calculating a total access time (e.g., tON+tPRE) of the row (e.g., Row #1) using the open time and a precharge time (tPRE), and (iii) calculating an equivalent number of activation (EACT) (e.g., EACT=(tON+tPRE)/tRC) using the total access time of the row and the predetermined time period (e.g., tRC). If the EACT value is equal to or larger than a predefined value (e.g., 1), then the RP logic operation 112 can (i) determine the open row (e.g., Row #1) as defective for being open/activated for at least the predetermined time period, and (ii) send, to the RH logic operation 122, the signal 114 (e.g., request message) requesting an increment of the activation counts for the defective memory row (e.g., Row #1). The signal 114 can carry the EACT value. The EACT value may be an 8 bit, 9 bit, 10 bit, 11 bit, 12 bit, 13 bit, 14 bit, 15 bit, 16 bit, 17 bit, 18 bit, 19 bit, 20 bit, 21 bit, 22 bit, 23 bit, 24 bit, 25 bit, 26 bit, 27 bit, 28 bit, 29 bit, 30 bit, 31 bit, 32 bit number. In some embodiments, the EACT value has less than 8 bits. In some embodiments, the EACT value has greater than 32 bits. In some embodiments, the EACT value is represented in a positive integer. In some embodiments, the EACT value is a double or a float.

After the RH logic operation 122 receives the signal 114, the fractional activation counter 118 is configured to increment the activation count of the defective memory row (e.g., Row #1) by the EACT value, which can be an integer or a fractional non-integer value. The fractional activation counter 118 can also increment the activation count (e.g., by an integer, or a fractional non-integer value) when the row (e.g., Row #1) is activated/opened naturally or by Rowhammer error (besides RP error). When the activation count for the defective memory row (e.g., Row #1) is above the specified TRH, the defect tracker 104 can cause, via the refresher (RF) trigger module 120, corresponding refresher(s) (e.g., RF #2) on the respective memory bank (e.g., 103a) to refresh adjacent row(s) (e.g., Row #2) of the defective row (e.g., Row #1).

In FIGS. 1A-1B and 1D, each timer register (e.g., 108a-108n) can have at least 10 bits, and the fractional non-integer value can have 7 bits. In some embodiments, the device 100a-100b and 100d can further include an error correction code circuit or a detection circuit configured to tolerate RH error. In some embodiments, each timer register (e.g., 108a-108n) is configured with 8 bit, 9 bit, 10 bit, 11 bit, 12 bit, 13 bit, 14 bit, 15 bit, 16 bit, 17 bit, 18 bit, 19 bit, 20 bit, 21 bit, 22 bit, 23 bit, 24 bit, 25 bit, 26 bit, 27 bit, 28 bit, 29 bit, 30 bit, 31 bit, 32 bit number. In some embodiments, non-integer value can have 4 bit, 5 bit, 6 bit, 7 bit, 8 bit, 9 bit, 10 bit, 11 bit, 12 bit, 13 bit, 14 bit, 15 bit, 16 bit, 17 bit, 18 bit, 19 bit, 20 bit, 21 bit, 22 bit, 23 bit, 24 bit, 25 bit, 26 bit, 27 bit, 28 bit, 29 bit, 30 bit, 31 bit, 32 bit number.

In an embodiment, the specified TRH is configured to establish as TRH/1.35 or 0.74×TRH of a double data rate 4 (DDR4) device. In another embodiment, the specified TRH can be established from a Rowhammer threshold scaled by a value for a given DDR device.

Whole or fractional Defect Tracker (104)—Memory-Controller (MC)-Based Tracker. In FIGS. 1C and 1E, each defect tracker (MC-based trackers) 104a-104n is (i) implemented as part of an independent memory controller (MC) 132 and (ii) configured to communicate (e.g., sending signal 114), via a communication bus 134, with a respective memory bank (e.g., 103a-103n) and every row and refresher thereof.

In FIG. 1C, each defect tracker 104 can (i) detect an RP error on a defective row (e.g., Row #1) of a memory bank (e.g., 103a) using a corresponding timer register (e.g., 108a) and the open-address register 110 on the RP logic circuit 106, and (ii) keep track of the number of activations (e.g., caused by RH or RP) using the integer activation counter 118 on the RH logic circuit 116, to trigger, using the RF trigger module 120 and via the communication bus 134, refreshment of adjacent rows (e.g., Row #2) on the same memory bank (e.g., 103a) when a threshold number of activations is exceeded.

In FIG. 1E, each defect tracker 104 can (i) detect an RP error on a defective row (e.g., Row #1) of a memory bank (e.g., 103a) using only a corresponding timer register (e.g., 108a) on the RP logic circuit 106, and (ii) keep track of the number of activations using the fractional integer activation counter 118 on the RH logic circuit 116, to trigger, using the RF trigger module 120 and via the communication bus 134, refreshment of adjacent rows (e.g., Row #2) on the same memory bank (e.g., 103a) when a threshold number of activations is exceeded.

RH and RP Probability Determination. In FIGS. 2A-2B, the device 200 (shown as 200a-200b) can first estimate, via the probabilistic circuit 202, a probability value (denoted as p) of an occurrence of an RH or RP event in a row (e.g., Row #1) of a memory bank (e.g., 103a). Then, the device 200 can determine, via the RP logic operation 112, row open time from a starting time when the row (e.g., Row #1) is open in the memory bank to a stopping time when the memory row is closed over a fixed-length time window in the bank, using a corresponding timer register (e.g., 108a). After the RH logic operation 122 receives, from the RP logic operation 112, the row open time, the device 200 can further recalculate the probability value of the occurrence of the RH and RP event using the row open time from the corresponding timer register (e.g., 108a). The recalculated probability value can be p(w+1), where w is the row open time (e.g., an output) of the corresponding timer register (e.g., 108a).

### Example Operation Flow

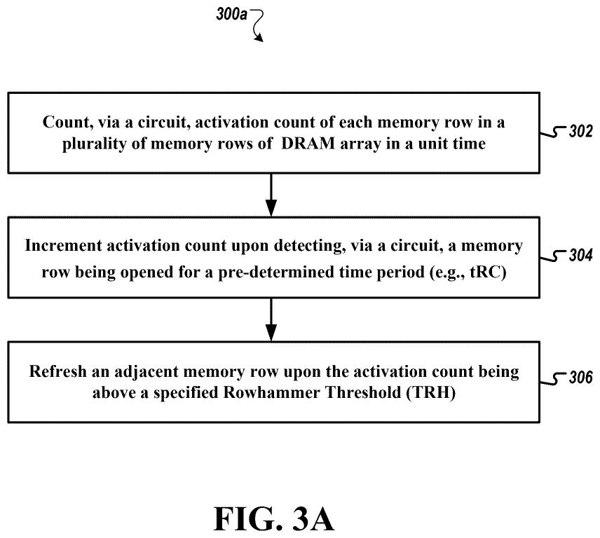

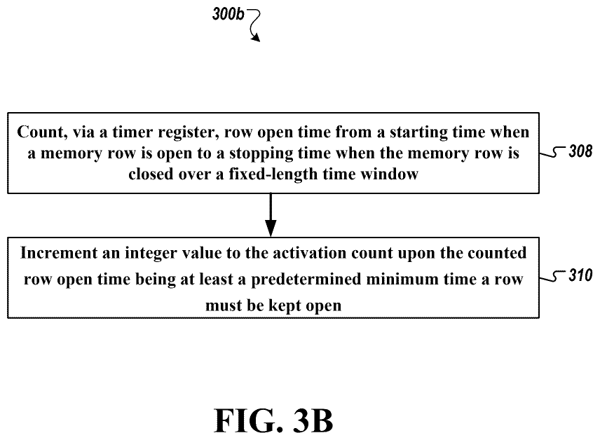

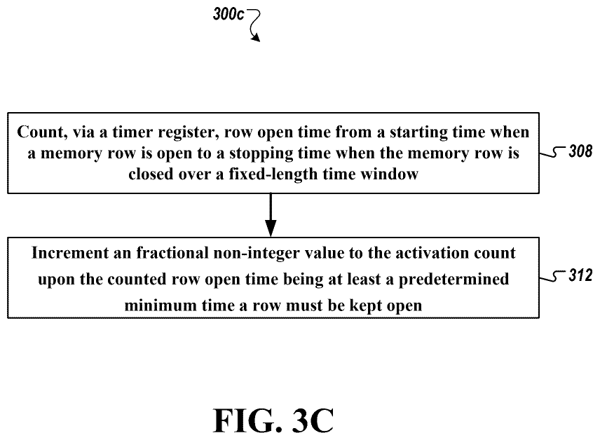

FIGS. 3A-3C show example operation flows 300a-300c of a defect tracker (see 104, FIGS. 1-2), operatively coupled to a DRAM array (see 102, FIGS. 1-2), of the exemplary device, in accordance with an illustrative embodiment. The defect tracker can be a memory controller, a memory-controller-based tracker, or an in-DRAM tracker.

FIG. 3A shows the overall operation flow 300a of the defect tracker. As shown, the method 300a includes counting (302), via a circuit (see 116, FIGS. 1-2), an activation count of each memory row in a plurality of memory rows of the DRAM array in a unit time. Method 300a includes incrementing (304) the activation count upon detecting, via a circuit (see 106, FIGS. 1-2), a memory row (e.g., defective row) being opened for a predetermined time period (e.g., row-cycle time (tRC)). Method 300a includes refreshing (306) an adjacent memory row upon the activation count being above a specified Rowhammer Threshold (TRH).

FIG. 3B shows the operation flow 300b of the defect tracker when detecting a defective memory row. As shown, the method 300b includes counting (308), via a timer register (see 108, FIGS. 1-2), row open time (e.g., of the defective row) from a starting time when a memory row is open to a stopping time when the memory row (e.g., defective row) is closed over a fixed-length time window. Method 300b includes incrementing (310) an integer value to the activation count upon the counted row open time being at least a predetermined minimum period for a row to be kept open.

FIG. 3C shows another operation flow 300c of the defect tracker when detecting a defective memory row. As shown, the method 300c includes counting (308), via a timer register (see 108, FIGS. 1-2), row open time (e.g., of the defective row) from a starting time when a memory row is open to a stopping time when the memory row (e.g., defective row) is closed over a fixed-length time window. Method 300b includes incrementing (312) a fractional non-integer value to the activation count upon the counted row open time being at least a predetermined minimum period for a row to be kept open. The fractional non-integer value can have 7 bits or other format described herein.

In FIGS. 3B-3C, the timer register can have at least 10 bits (or other format described herein). In one embodiment, the specified Rowhammer Threshold can be established as TRH/1.35 or 0.74×TRH of a DDR4 device. In another embodiment, the specified Rowhammer Threshold can be established from a Rowhammer threshold scaled by a value for a given DDR device.

### Example DRAM Chips/Arrays

DRAM chips can be organized as banks, two-dimensional arrays of memory rows and columns. To access data from DRAM, a memory controller can first issue an activation (ACT) to open a row. The row can continue to be open until the row is (i) proactively closed by the memory controller (e.g., closed-page policy), (ii) closed due to a row conflict to service data from another row, or (iii) closed to perform refresh.

DRAM can have deterministic timings specified as part of the Joint Electron Device Engineering Council (JEDEC) standards. Table 1 shows example timing parameters and operations in a DRAM chip/array.

TABLE 1

| Parameter | Description | Value | |
|---|---|---|---|
| tACT | Time for performing an ACT | 12 | ns |
| tPRE | Time to precharge an open row | 12 | ns |
| tRAS | Minimum time a row must be kept open | 36 | ns |
| tRC | Time between successive ACTs to a bank | 48 | ns |
| tREFW | Refresh Period | 32 | ms |
| tREFI | Time between successive REF Commands | 3900 | ns |
| tRFC | Execution Time for REF Command | 350 | ns |
| tON | Time the current row is open (dynamic value) | — | |
| tONMax | Max time a row can be kept open per DDR5 | 19.5 | μs |

| | | |
|---|---|---|
| tMRO | Max time a row can be kept open by the MC | — |

All data in DRAM can be refreshed every tREFW. To reduce the latency impact of refresh, memory can be divided into 8192 groups, and a refresh pulse can be sent every tREFI interval to refresh one group. Double Data Rate 5 (DDR5) specifications allow the postponement of up to 4 refreshes, so the time between refreshes can be up to 5 times tREFI.

Example RH Trackers. The defect tracker (see 104, FIGS. 1-2) of the exemplary device can be a memory-controller-based (MC-based) tracker or an in-DRAM tracker. The in-DRAM tracker can solve the RH problem inside the DRAM, without relying on external circuitries. Table 2 shows example RH trackers that were evaluated in the study and that can be employed as the controller of the exemplary device. Each RH tracker is generally configured to identify aggressor rows (i.e., defective rows) and perform mitigative refresh on the victim rows (e.g., rows adjacent to the aggressor rows).

TABLE 2

| RH Tracker | Description |
|---|---|
| Graphene [30] | Graphene uses the MisraGries algorithm to |
| (counter, MC-based) | identify rows that reach TRH activations |
| | and issue a mitigation. The number of |
| | tracking entries (per bank) is inversely |
| | proportional to the RH threshold. |
| PARA [21] | PARA selects each activation for mitigation |
| (probabilistic, MC-based) | with a probability p, which is determined |
| | based on a target failure rate. |
| Mithril [18] | Mithril uses a counter-based summary to |
| (counter, in-DRAM) | identify heavily activated rows. Mitigation |
| | is performed on the reception of the RFM |
| | command (sent by a memory controller every |
| | RFMTH activation) at the row with the highest |
| | count. The number of entries depends on |
| | RFMTH and TRH. |
| MINT [31] | MINT achieves RH mitigation with a single |
| (probabilistic, in-DRAM) | entry per bank. At each RFM, MINT mitigates |
| | the identified aggressor row and randomly |
| | selects which activation slot in the upcoming |
| | RFMTH activations to be selected for |
| | mitigation. |

### Experimental Results and Additional Examples

A study was conducted to develop and evaluate an experimental device (also referred to as “ImPress”) comprising (i) a DRAM array having a plurality of memory rows and (ii) one or more defect trackers configured to (a) detect, via a Row-Press (RP) logic circuit and a Rowhammer (RH) logic circuit, at least one defective memory row and (b) trigger corresponding refreshers of the DRAM array, upon an excession of activation counts of the defective row, to refresh adjacent rows of the defective row, as described in relation to FIGS. 1-2.

The study developed two embodiments of the experimental device (“ImPress”). The first embodiment of the experimental device, referred to as ImPress-N (naïve ImPress), was configured to handle only integer values of charge loss. The study implemented ImPress-N to demonstrate the impact of reduced precision on the effectiveness of the experimental device. ImPress-N can divide the time into windows of row-cycle time (tRC); if a row is open for the entire window, then ImPress-N treats the open time as equivalent to an activation for RH mitigation. Thus, ImPress-N can limit the impact of any unmitigated Row-Press (RP) to at most one tRC window.

Configuration and Operation. In ImPress-N, Rowhammer (RH) mitigations are configured to tolerate the worst-case RH pattern, causing an activation in each time window of tRC. With RowPress, if a row is kept open for a long time, such a pattern may not cause as many activations as the worst case. If the RP activity can be converted into RH activity, then current RH-mitigation solutions (e.g., RH trackers) can be used to mitigate RP.

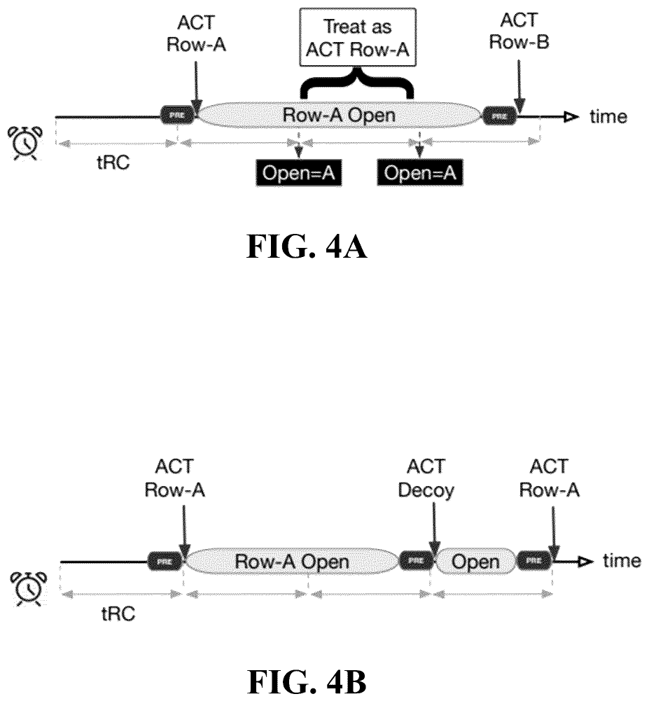

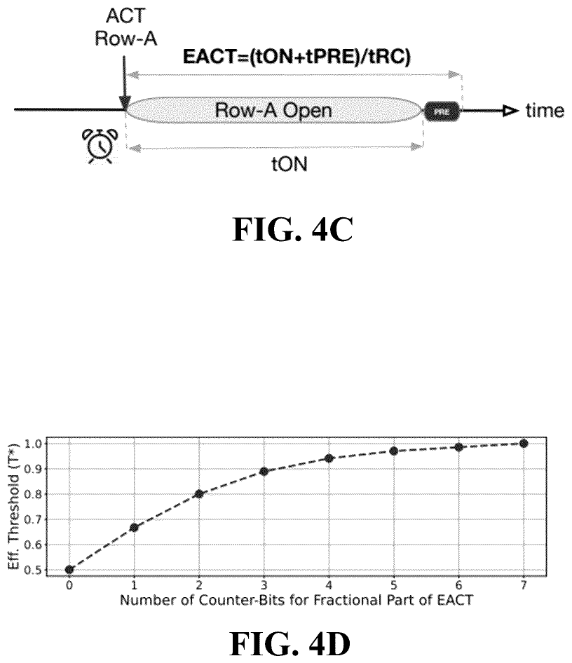

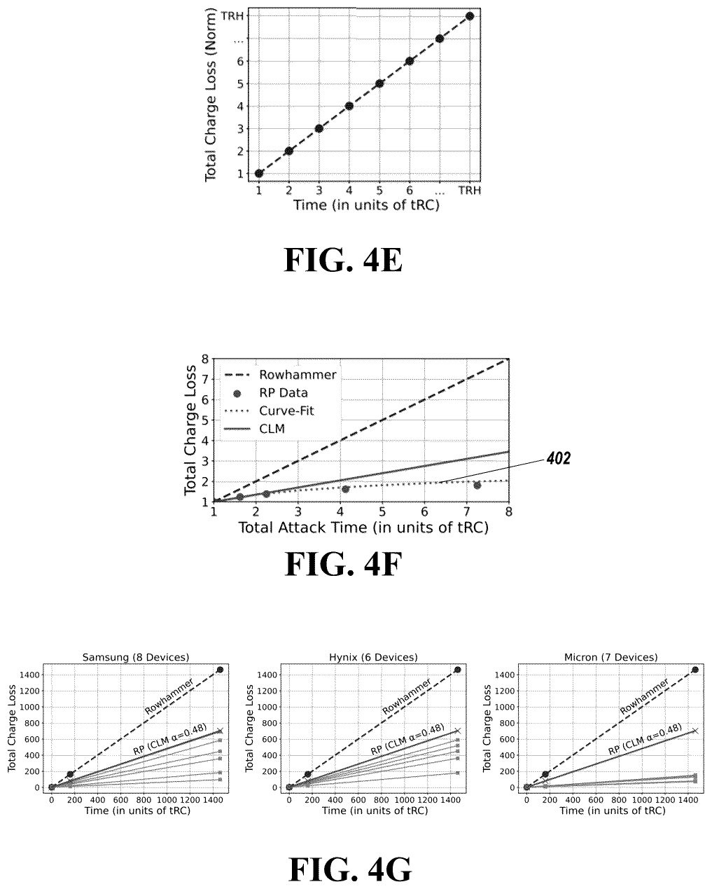

FIG. 4A shows the configuration and operation of ImPress-N. As shown, ImPress-N can divide time into windows of tRC. If a row activation occurs within the window, that row participates in the RH mitigation, which is the case for Row-A in the second window and Row-B in the fourth window. Furthermore, if a row is kept open for the entire tRC window, then the open row can be treated as equivalent to causing a row activation for that open row, and the open row participates in RH mitigation. For example, Row-A, which is open for tRC during the third window, is treated as causing an activation on Row-A for RH mitigation.

To implement ImPress-N, the study used two counters: (i) a Timer register (see 108, FIGS. 1-2) that identifies the ending time of each window, and (ii) an Open-Row Address (ORA) register (see 110, FIGS. 1A-1C) that stores the row address of the open row at the end of each window. If the address to store in ORA is the same as the address present in ORA, the row is open for the entire window and participates in the RH tracking mechanism, similar to causing an activation.

ImPress-N can be incorporated into current RH-mitigation solutions (e.g., RH trackers), as the embodiment converts RP activity into a series of ACTs, which can be handled by RH-mitigation, so the controller (e.g., memory controller, in-DRAM tracker) may not need to be changed. The total storage for implementing ImPress-N is 1 byte for the Timer, and 3 bytes for the ORA, for a total of 4 bytes per bank (32 bytes per chip).

Impact of Unmitigated Row-Press. ImPress-N can convert an RP pattern that keeps a row open over multiple tRC windows into an equivalent number of ACTs (one per tRC). However, as ImPress-N operates on integer values, it does not mitigate RP at a granularity of less than tRC. An attack can exploit this to reduce the RH threshold.

FIG. 4B shows a worst-case pattern for ImPress-N, where an attacker focuses on causing an undetected RP on Row-A. As shown, the pattern causes an activation for Row-A at a time within the precharge time (PRE) of the ending of the current window. As Row-A is still not open, it will not be stored in the ORA. The pattern keeps Row-A open for a time equal to (tRC+tRAS). As Row-A is open at the end of the current tRC window, the address of Row-A is stored in ORA. During the subsequent window, at a point before the precharge time from the end of the window, an ACT is sent for a decoy row, which causes precharge and closes Row-A. Thus, at the end of the window, ORA gets an invalid row. The pattern is repeated.

For each round of the pattern, the RH mitigation may see only a single ACT for Row-A, and thus treat this as an RH attack, causing a charge loss of 1 per round for Row-A. As the tON time for Row-A is (tRC+tRAS), Equation 6 can be used to quantify the charge loss per round as (1+α), where α is a relative charge leakage per tRC for RP. Thus, the Effective RH Threshold, denoted as T*, for ImPress-N can be computed per Equation 1.

$${T}^{*} = \frac{TRH}{1 + α} \qquad ( Eq . 1 )$$

In Equation 1, the impact on the RH threshold depends on a. The value of a from experimental data (tON≤2tRC) can be 0.35 (Luo et al.), so T* can be equal to TRH/1.35 or 0.74×TRH. If the study wanted device independence, then α=1 and T* equals TRH/2.

Fractional tracking. While ImPress-N is straightforward and efficient to implement (no changes to the trackers, except for some entries), it can still incur performance overheads, due to lowering the effective RH threshold resulting from unmitigated Row-Press that occurs at sub-tRC granularity. Furthermore, the impact of ImPress-N on the threshold depends on the value of a, and the study wanted a solution that offers protection of α=1 without any associated overheads.

The study developed a second embodiment of the experimental device, referred to as Impress-P (precise ImPress), to overcome the shortcomings of the first embodiment (“ImPress-N”). The study configured ImPress-P to (i) measure the tON time of a row and (ii) use the tON time to determine the Equivalent Number of Activations (EACT) between the time the row is opened and it completes precharge. ImPress-P does not lower the RH threshold due to mitigating Row-Press.

Configuration and Operation. In ImPress-P, RH mitigations are configured to tolerate the rate of damage that occurs under the RH pattern. So, the study can treat every time unit in terms of tRC (integer or fractional) as equivalent to that amount of ACTs (integer or fractional), allowing for the precise conversion of any amount of RP activity into equivalent RH activity, and the use of current RH-mitigation solutions (e.g., RH trackers) to mitigate RP without lowering the RH threshold.

FIG. 4C shows the configuration and operation of ImPress-P. ImPress-P may employ only one timer (see 108, FIGS. 1-2) to measure the time a row is open (tON). The timer starts when the row is opened and stops when the row is closed. The total duration for access should also include the time required for precharge, so the total time equals (tON+tPRE). The total time can be divided by tRC to get the Equivalent Number of ACTs (EACTs). For example, if tON is equal to tRAS (same as RH attack), then EACT equals 1. If tON equals tRAS+tRC, the access lasts for two tRC, and EACT equals 2. EACT may be at least 1, but it may be a fractional value (e.g., if tON=tRAS+tRC/2, EACT=1.5). Thus, the RH-mitigation solutions (e.g., RH trackers) should handle a non-integer number of ACT.

For counter-based tracking algorithms, the study modified the counters to support fractional values, and instead of incrementing by 1, the study incremented the counter by EACT. For probabilistic solutions, the study modified the selection probability from p to p*EACT. Thus, ImPress-P can be applicable to both types of trackers (e.g., memory controller-based and in-DRAM).

ImPress-P may require a single Timer (e.g., 10-bit timer) per bank (e.g., 32 per chip). All DRAM activity can occur and be measured at the granularity of DRAM cycles. For a 2.66 GHz DRAM, tRC (e.g., 48 ns) equals 128 cycles; thus, the division by tRC can be implemented by shifting right by 7 bits.

Impact ofCounter Precision on Effective RH Threshold. The fractional part of EACT can be 7 bits (due to division by tRC). For the counter-based tracking algorithms, the counter should also be extended by 7 bits to incorporate the fractional values of EACT. In some embodiments, the counter-based tracker can be modified with fewer bits to store the fractional value (to save on storage) at the expense of some error in tracking, leading to an equivalent reduction in the effective threshold (T*).

FIG. 4D shows the effective RH threshold (T*) of ImPress-P, as the number of counter-bits used for storing the fractional part varies from 0 to 7. As shown, with 7 bits T* equals TRH (no reduction in threshold). With fewer than 7 bits, e.g., b bits, a precision of

$$\frac{1}{{2}^{b}}$$

can be obtained, so the loss in accuracy equals

$$\frac{1}{{2}^{b}} .$$

Thus, with 6 bits, T* reduces to 0.985, with 5 bits to 0.97, and with 4 bits to 0.94. Finally, if the fractional part has 0 bits, ImPress-P may become ImPress-N, and has T* of 0.5 times TRH.

ImPress-P can use 7 bits for the fractional part, so ImPress-P maintains the same TRH with Row-Press protection as a system without any Row-Press protection. Furthermore, ImPress-P does not depend on a because it is configured for α of 1. Thus, while implementing and comparing different systems with ImPress-P, the study used α=1.

### Unified Charge-Loss Model for Experiments

The experimental device can convert the time incurred for Row-Press (RP) to an equivalent activation count for Rowhammer (RH). Before developing and analyzing the experimental device, the study developed a unified charge-loss model for RH and RP.

Relative Charge-Loss Model for Rowhammer (RH). Consider a DRAM cell that is the target of an RH attack. After Rowhammer threshold (TRH) activations to an aggressor row, the total charge loss experienced by the target DRAM cell should exceed some value to cause a bit flip. The study configured the unified charge-loss model to quantify the total charge loss, incurred after K activations, to the target DRAM cell as a relative metric. Let the relative charge-loss per activation (CA) be 1 unit; then the total charge loss (TCL_{RH}), by Rowhammer (RH) after K activations, can be defined per Equation 2.

$${TCL}_{RH} = K \cdot {C}_{A} = K \cdot 1 = K \qquad ( Eq . 2 )$$

As a bit-flip may occur after TRH activations, the total charge loss should be in TRH units, representing the value of the critical charge loss. FIG. 4E shows a relative charge-loss model for RH, where time is counted in terms of row-cycle time (tRC). As shown, RH is a perfect linear attack—one unit of damage in one unit of time.

Relative Charge-Loss Model for Row-Press (RP). The charge loss for RP may come from two sources: (1) the activation and the time incurred in the first tRC, the impact of which can be identical to an RH pattern, so this time period can incur a charge-loss of 1 unit, and (2) the time-dependent charge loss that occurs because the row is kept open for an additional time, which can be computed per Equation 3.

$$Additional time = tON - tRAS \qquad ( Eq . 3 )$$

In Equation 3, tON is the time the row is open, and tRAS is the minimum time any row should be kept open. As all times can be normalized to tRC, the additional time can also be normalized to tRC. The total charge loss (TCL_{RPA}) from an RP pattern that keeps a row open for tON time can be computed per Equation 4.

$${TCL}_{RPA} = 1 + f ( \frac{Additional time}{tRC} ) = 1 + f ( \frac{tON - tRAS}{tRC} ) \qquad ( Eq . 4 )$$

In Equation 4, the function f captures the rate of charge leakage per unit time (in terms of tRC) for RP. The function f can be estimated using the characterization data or picked conservatively to never be below the observed data.

If data for effective RH threshold T* is available, the relative charge leakage, incurred by a single round of an RP attack (for a given tON time), can be deducted, compared to the charge leakage incurred by a single round of an RH attack. For example, if the RP attack causes T* to be half of TRH, then each round of RP attack may leak 2× the charge as a single round of RH attack. This detail may be used to estimate the charge-leakage versus the attack time for an RP attack. As an RP attack may end with a precharge, the total time for an RP attack can be defined per Equation 5.

$$Total time for RP attack = tON + tPRE \qquad ( Eq . 5 )$$

FIG. 4F shows a relative charge-loss model for RP, and compares the total-charge loss for the RP attack to that of an RH attack, as the attack time increases from 1 tRC to 8 tRC. As shown, RH is a linear attack (K units of charge-loss in K units of time). The dots on line 402 represent the charge loss derived from the data of Luo et al. [25].

Conservative Linear Model (CLM). The study tried a curve-fit on the experimental data (see line 402, FIG. 4F) under two constraints: (1) the function should be simple for implementation in hardware, e.g., inside the DRAM chip, and (2) the function should not underestimate the total charge loss (TCL) observed in the chips, as underestimation can cause reliability and security failures if the actual loss is greater than the predicted loss. Based on the two constraints, the study developed a Conservative Linear-Model (CLM) that provided a linear relationship, albeit a conservative one. Rather than looking for the best fit and having an error in both directions, CLM can produce a line such that no observed data point is above the line. The general form of the CLM is defined per Equation 6.

$${TCL}_{ON} = 1 + α * ( \frac{tON - tRAS}{tRC} ) \qquad ( Eq . 6 )$$

In Equation 6, a is the relative charge leakage per tRC for RP (α=1 gives RH). For the data from Luo et al. (as shown in FIG. 4F), α=0.35, so Equation 6 can become Equation 7.

$${TCL}_{RPA} = 1 + 0.35 * ( \frac{tON - tRAS}{tRC} ) \qquad ( Eq . 7 )$$

RP attack may become an RH attack if tON equals tRAS. Thus, Equation 6 can represent a generalized equation incorporating RH and RP for any pattern.

Row-Press at Large Time Scale. The experimental data in FIG. 4F is for a small-duration (sub-microsecond) RP attack. However, RP attacks can also be long-duration, lasting up to one tREFI without refresh postponement and up to 5×-9× times tREFI (DDR5-DD4) with refresh postponement.

FIG. 4G shows the Total Charge Loss (TCL), caused by long-duration RP attacks that last for 1 tREFI (162 tRC in DDR4) and 9 tREFI (1462 tRC in DDR4), for Samsung, Hynix, and Micron memory devices, where time is normalized in terms of tRC. For comparison, FIG. 4G shows the TCL of RH if RH is performed for an identical duration. FIG. 4G also shows the CLM model for RP with α=0.48, as the CLM can cover all the characterized devices. Thus, the study used the model of Equation 6 to model both short-duration and long-duration RP attacks.

### Experimental Methodology

Performance Methodology. The study used ChampSim [7], a cycle-level multi-core simulator, interfaced with DRAMSim3 [24], a detailed memory system simulator. The study enhanced DRAMSim3 to support DDR5. Table 3 shows the configuration for the baseline experimental device of the study. The study used a Minimalist Open-Page (MOP) memory mapping with 8 consecutive lines per row. For refresh management (RFM), the study used a latency of 205 ns (half of tRFC) and a default refresh management threshold (RFMTH) of 80.

TABLE 3

| | |
|---|---|
| Out-of-Order cores width | 8 cores at 4 GHz, 6-wide |
| Reorder buffer (ROB) size | 352 |
| Last level cache (shared) | 16MB, 16-Way, 64B lines, |
| | static re-referenced interval |
| | prediction (SRRIP) |
| Memory size | 64GB - DDR5 |
| Channels | 2 (32GB DIMM per channel) |
| Banks × Ranks × Sub-Channels | 32 × 1 × 2 |
| Memory mapping | Minimalist Open Page (8 lines) |

The study used two categories of workloads: (i) the 10 SPEC2017 [41](8-core rate mode) traces available from ChampSim to explore the impact of tMRO on conventional workloads, and (ii) 4 streaming workloads [28](8-core rate mode) and 6 mixed streaming workloads (two with 4 copies each), to explore the impact of tMRO on high-locality workloads. For each workload, the trace represents the region of interest. The study warmed up the experimental device for 50 million instructions and ran each workload for 200 million instructions. The study reported the performance as normalized weighted-speedup.

Reliability Methodology for RH Trackers. In the experiment, the study performed mitigation by refreshing the victim rows, using various RH trackers, including Graphene, PARA, Mithril, and MINT (see Table 2). To mitigate RH and RP, the study configured the parameters of the RH trackers as described herein: a default TRH of 4K [17], and a target bank-failure rate of 0.1 FIT (i.e., 1 failure per 10 billion hours, 30× lower than the rate of naturally occurring errors [2]) for probabilistic RH trackers (e.g., PARA, MINT).

Based on the target failure rate, the study configured PARA with p=1/184. For Graphene, the number of entries was inversely proportional to TRH. To tolerate a TRH of 4K, Graphene needed 448 entries per bank (115 KB SRAM per channel).

Mithril performed mitigation transparently under the RFM command, which was issued every RFMTH activation per bank. For mitigation, Mithril selected the aggressor row with the highest counter value. For a given mitigation rate (1 per RFMTH), the study determined the number of entries required to tolerate a given threshold using Theorem 1 of [18]. For example, for RFMTH of 80, Mithril needed 383 entries per bank (86 KB SRAM per channel) to tolerate a TRH of 4K.

MINT required a single entry per bank to keep track of the row to be mitigated at RFM. At each RFM, MINT mitigated the given aggressor row, then randomly selected which activation slot in the upcoming RFMTH (e.g., 80) activations would be chosen for mitigation at the next RFM. As MINT lacked configurability (for a fixed RFMTH), the study reported the threshold tolerated by MINT as the figure of merit.

### Impact of ImPress-N on RH Trackers

The study applied ImPress-N and Explicit Row-Press mitigation system/method (ExPress) to the four RH trackers: PARA, Graphene, Mithril, and MINT. For PARA and Graphene, both ImPress-N and ExPress had similar performance overheads as they needed to be operated at a reduced RH threshold (e.g., 2× lower). For Mithril and MINT, ImPress-N can make RP mitigation viable at small performance overheads.

Unlike ExPress [25], ImPress-N does not place any limit on tON, so ImPress-N does not experience reduced row-buffer hits due to premature closing of an open row due to tMRO. However, ImPress-N still incurs performance overheads from the extra mitigations due to the reduction in threshold (T*) and from considering rows opened for tRC as an ACT. To ensure that both systems (e.g., ImPress-N, ExPress) targeted the same T*, the study evaluated ExPress with tMRO set to (tRAS+tRC).

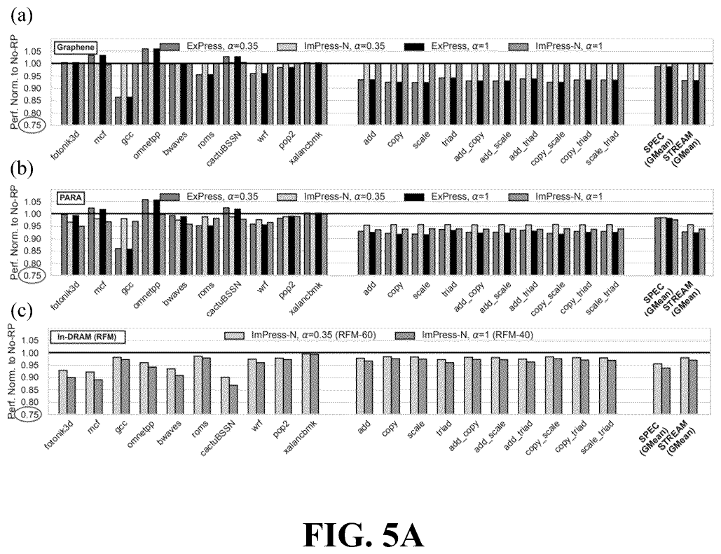

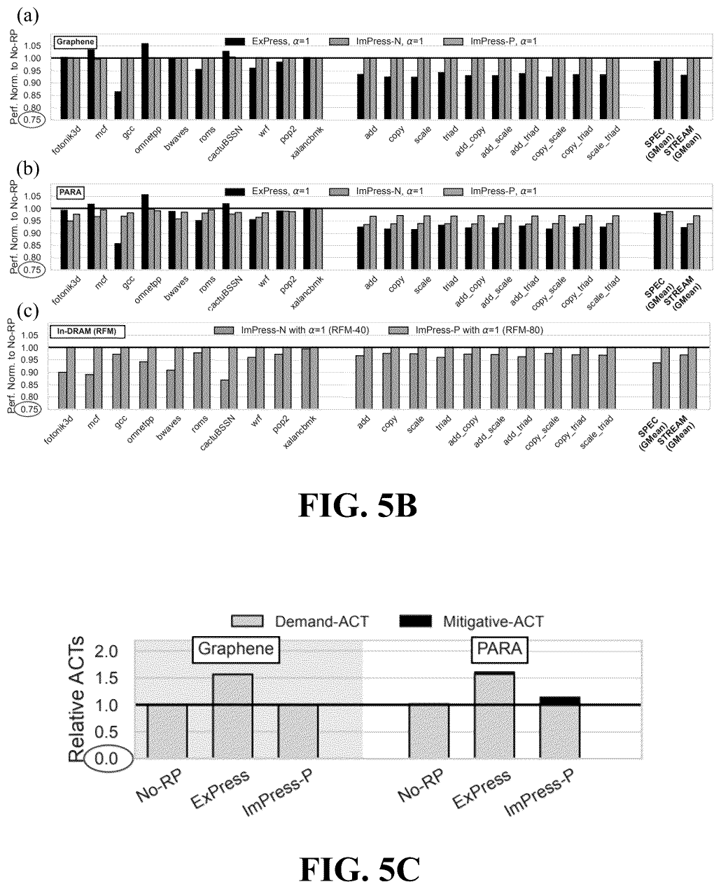

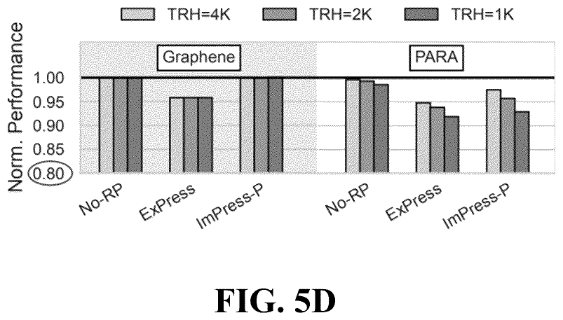

FIG. 5A, subpanels (a)-(c) show the performance, normalized to No-RP (e.g., baseline system not experiencing RP or has no RP protection), of Graphene, PARA, and MINT trackers, with ImPress-N and ExPress, respectively.

Impact on Graphene. For TRH of 4K, Graphene used an internal threshold of 1333 (mitigation was sent when counters reached the internal threshold), requiring 448 entries per bank (115 KB SRAM per channel). To make Graphene Row-Press-tolerant with ImPress-N or ExPress, the number of entries was increased in direct proportion to (1+α). Thus, for a of 0.35, Graphene required 605 entries per bank (155 KB SRAM per channel), and α of 1, Graphene required 896 entries per bank (230 KB SRAM per channel). Thus, both ImPress-N and ExPress required a total storage overhead of 1.35×-2× compared to the No-RP baseline system/configuration.

As Graphene was efficient in sending mitigative refreshes, the slowdown came from the reduction in row-buffer hits. In FIG. 5A, subpanel (a), for Stream workloads, ExPress incurred an average slowdown of 7.5%, whereas ImPress-N incurred a negligible slowdown. For SPEC workloads, ImPress-N and ExPress had similar performance.

Impact on PARA. For TRH of 4K, PARA required p to be 1/184. At α of 0.35, p increased by 1.35× to 1/136, for both ExPress and ImPress-N. At α of 1, p increased to 1/92 for both ImPress-N and ExPress. In FIG. 5A, subpanel (b), for Stream workloads, ExPress incurred an average slowdown of 8% (at a of 0.35) and 8.4% (for a of 1), whereas ImPress-N incurred an average slowdown of 4.7% (at a of 0.35) and 6.7% (for α of 1). Overall, ImPress-N performed better than ExPress. ExPress was incompatible with in-DRAM trackers, so the study evaluated Mithril and MINT only with ImPress-N.

Impact on Mithril. The study set a default RFM Threshold (RFMTH) of 80. For such RFMTH, to handle a TRH of 4K, Mithril required 383 entries. To account for the unmitigated RP of ImPress-N, Mithril would need to target a revised threshold (T*) of either 2963 (α=0.35) or 2000 (α=1). Thus, the number of entries of Mithril increased from 383 to 615 (α=0.35) or 1545 (α=1), and Mithril did not incur any additional performance overheads.

Impact on MINT. The study set an RFMTH of 80 for MINT, so MINT could tolerate a TRH of 1.6K for No-RP. Due to the unmitigated Row-Press of ImPress-N, the tolerated threshold increases to 2.1K (α=0.35) and 3.1K (α=1). Alternatively, the study could reduce RFMTH to 60 (α=0.35) or 40 (α=1) to retain the same tolerated TRH (of 1.6K). In FIG. 5A, subpanel (c) shows the slowdown of RFM-60 and RFM-40 compared to RFM-80. The average slowdown was small, and ranged from 3% to 5%.

### Impact of ImPress-P on RH Trackers

Unlike ExPress, ImPress-P does not place any limit on tON. Thus, ImPress-P does not impact performance due to the early closure of an open row. Furthermore, as ImPress-P does not affect the threshold, ImPress-P also does not incur any additional mitigations due to activations compared to an idealized baseline system that does not have Row-Press (e.g., No-RP baseline system). However, ImPress-P can still incur additional mitigations due to a row being kept open for a long time.

The study analyzed ImPress-P, ImPress-N, and ExPress for the RH trackers (e.g., Graphene, PARA, Mithril, MINT). The study implemented ExPress with tMRO of tRAS+tRC. As ExPress was incompatible with in-DRAM trackers (e.g., Mithril and MINT), the study compared ImPress-P to only ImPress-N for Mithril and MINT.

FIG. 5B shows the performance, normalized to No-RP (e.g., baseline system not experiencing Row-Press), of Graphene, PARA, and MINT trackers, with ImPress-N, ImPress-P, and ExPress.

Impact on Graphene. For TRH of 4K, Graphene required 448 entries per bank. Both ImPress-N (α of 1) and ExPress doubled it to 896 per bank. With ImPress-P, the number of entries remained unchanged at 448, but each entry required 7 bits of extra storage to store fractional values of EACT; hence, in FIG. 5B, subpanel (a), ImPress-P incurred 25% storage overhead (each entry was 28 bits). Thus, the total storage required for ImPress-P was only 1.25× of No-RP, whereas it was 2× for both ImPress-N and ExPress. ImPress-P does not affect the threshold or restrict tON, so ImPress-P incurred a negligible overhead.

Impact on PARA. PARA used a constant probability p for all activations, e.g., PARA used p=1/184 for TRH of 4K, and PARA used p=1/92 for ImPress-N and ExPress. ImPress-P caused PARA to use a variable value for p for each activation, depending on the tON time (e.g., \hat{p}=p*EACT, for each activation). In FIG. 5B, subpanel (b), ImPress-P reduced performance overheads (e.g., for Stream workloads) compared to ExPress.

Impact on Mithril. For TRH of 4K and a default RFMTH of 80, the number of entries Mithril required was 383, which increased to 1545 (4×) with ExPress and ImPress-N (α=1). With ImPress-P, the number of tracking entries remained unchanged at 383, but each entry was provisioned with 7 more bits to track the fractional values, which resulted in 25% storage overheads, less than the 4× overhead required for ExPress and ImPress-N. Due to RFM commands, Mithril's performance overheads remained the same as the No-RP baseline system.

Impact on MINT. MINT contained three registers: SAN (Selected Activation Number), CAN (Current Activation Number), and SAR (Selected Address Register). Both SAN and SAR remained unchanged. The study modified CAN to have 7 more bits corresponding to the fractional value of EACT. For each activation, the study increased CAN by the value of EACT, so each activation got a selection probability in proportion to the EACT. If CAN crossed SAN, the row address would be stored in SAR. At RFM, the row address in SAR (if valid) was mitigated, and a new value for SAN was selected. ImPress-P increased the storage overhead of MINT from 4 bytes to 5 bytes. With ImPress-N, the RH threshold increased from 1.6K to 3.1K, whereas with ImPress-P, the RH threshold remained unchanged at 1.6K. In FIG. 5B, subpanel (c), ImPress-P had the same performance as No-RP.

### Additional Experimental Results

Table 4 compares the properties of ExPress, ImPress-N, and ImPress-P and highlights the shortcomings among the systems. As shown, ImPress-P requires minor changes (to include EACT) and provides near-ideal performance.

TABLE 4

| Property | ExPress | ImPress-N | ImPress-P |
|---|---|---|---|
| Puts a limit on tON | Yes | No | No |
| Affects threshold (T*) | Yes (up to 2x) | Yes (up to 2x) | No (1x) |
| Performance overheads | High | Medium | Low |
| More tracking entries | Yes (up to 2x) | Yes (up to 2x) | No (1x) |
| Wider tracking entries | No | No | Yes (minor) |
| In-DRAM Trackers | Incompatible | Compatible | Compatible |
| Device Dependency | Yes (alpha) | Yes (alpha) | No |

Activation Overheads. Tolerating Row-Press can cause extra activations due to row closure (ExPress) or additional mitigations. FIG. 5C shows activation overheads of Graphene and PARA, with No-RP, ExPress, and ImPress-P. As shown, Graphene without RP protection (No-RP) caused less than 1% extra activations. With ExPress, mitigative activations remained low, but demand activations increased by 56% for Graphene and 57% for PARA. Graphene with ImPress-P incurred no additional activation overhead.

For PARA, the extra demand activations with ImPress-P were negligible at 2% on average; however, the mitigative activations increased by 12%. ImPress-P had lower activation overhead than ExPress, e.g., reducing the activation overhead from 56% to 1% for Graphene, and 61% to 14% for PARA.

Energy Overheads. On average, activations accounted for 11% of the baseline DRAM energy. ExPress increased DRAM energy by 6% for Graphene and 7% for PARA. ImPress-P increased DRAM energy by only 1% for Graphene and 2% for PARA.

Scalability to Lower Rowhammer Threshold. FIG. 5D shows the performance of Graphene and PARA, normalized to an unprotected baseline (e.g., No-RP baseline), with No-RP, ExPress, and ImPress-P, as TRH varies from 1K to 4K. As shown, at TRH of 1K, Graphene incurred no slowdown with No-RP and ImPress-P, but a 4.4% slowdown with ExPress. PARA incurred a 1.5% slowdown with No-RP, an 8.9% slowdown with ExPress, and a 7.7% with ImPress-P. The storage overheads of Graphene and the performance overheads of PARA made them impractical for low TRH. For low TRH, some companies [3], [20] and JEDEC [14] have been adopting Per-Row Activation Counting (PRAC) where the DRAM array stores a counter for each row (8 KB). ImPress can be used with PRAC by having 7 bits of the counter for storing the fractional EACT.

### DISCUSSION

Over the last four decades, DRAM scaling has increased the capacity of DRAM chips from a few megabits to tens of gigabits. As DRAM cells get smaller, they become prone to inter-cell interference, where the activity in one cell can disturb the data in another cell, leading to Data-Disturbance Errors (DDE). DDEs are not just a reliability concern but also a security threat, as attackers can exploit DDEs to compromise system security [9], [38].

Rowhammer. A well-known DDE vulnerability of DRAM is Rowhammer (RH) [21]. Rowhammer occurs when an aggressor row is activated a large number of times, which causes bit-flips in the neighboring victim rows. Previous studies [1], [4], [6], [8], [9], [38], [42] have shown that Rowhammer can be exploited to compromise security. For example, an attacker can flip bits in page tables to escalate privilege [38], flip bits in instruction opcodes to bypass authentication [33], or analyze flipped bits to infer the data of nearby pages [22].

The number of activations (ACTs) to the aggressor row required to induce a bit-flip is called the Rowhammer Threshold (TRH). A publicly available characterization data report a TRH of 4.8K [17]. A common hardware-based defenses for Rowhammer rely on a tracking mechanism [16], [18], [21], [26], [30], [32], [40] to identify aggressors and refresh the victim rows [10]. The tracking can be at a memory controller (MC) or within the DRAM (in-DRAM). Solutions for mitigating RH are designed for a specific TRH, which assumes DRAM may not incur bit-flips if the activation count is below the specified TRH. These solutions can be broken if a vulnerability causes bit flips with fewer than TRH activations.

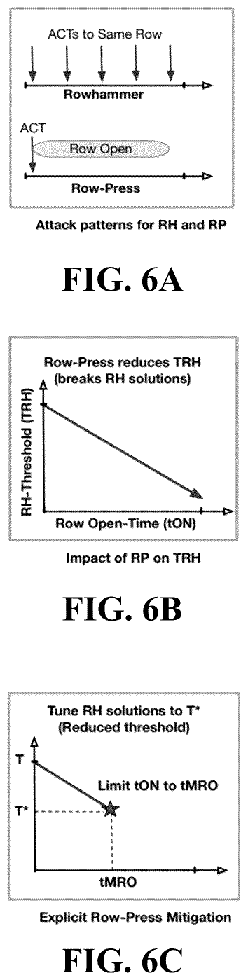

Row-Press. A previous study [25] disclosed a new DDE vulnerability, Row-Press (RP), which occurs when a row is kept open for a long time. While the row is open, the cells of the neighboring rows slowly leak charge onto the bit lines, and the cumulative charge loss increases with time. Therefore, a Row-Press pattern keeps the row open for as long as possible, until the row may close due to a row conflict or refresh operation. Such a Row-Press attack pattern is repeated until the charge on the neighboring cell is depleted enough to cause a flip. FIG. 6A shows the attack patterns of RH and RP.

The impact of Row-Press depends on how long the row is kept open. Each round incurs an activation of the given row. Luo et al. [25] provide a detailed characterization of Row-Press and show that the number of activation rounds required to succeed is 18× to 160× lower than the number of activations required by a standalone RH attack. If the row is kept open for 30 ms, then a single round of Row-Press attack may be enough to flip a bit.

FIG. 6B shows the impact of Row-Press on modifying a Rowhammer threshold (TRH) as a Rowhammer/Row-Press solution. RP reduces the number of activations required to cause a bit-flip to much lower than TRH (e.g., 18× lower than Rowhammer alone [25]). Thus, RP breaks RH-mitigation configured to tolerate a threshold of TRH, as such solutions assume that no bit-flip occurs if the row gets fewer than TRH activations. Therefore, RP is a serious security vulnerability.

Other Row-Press (ExPress) Mitigation Solutions. Luo et al. [25] developed the ExPress system and method to tolerate Row-Press attacks, which forces the Memory Controller (MC) to limit the amount of time a row can be kept open to the Maximum Row Open time (tMRO). For example, let TRH denote the threshold for the standalone RH attack. The number of activations required for Row-Press to flip bits is characterized, with the maximum aggressor open time (tON) being limited to tMRO. Luo et al. [25] configured the RH-mitigation to cater to a lower threshold (also called effective threshold), denoted as T*, instead of TRH. FIG. 6C shows an implementation of ExPress mitigation. A shortcoming of ExPress is that ExPress reduces the tolerated threshold from TRH to T*. Additionally, ExPress experiences the following three problems: high performance overheads, high storage overheads, and incompatibility with in-DRAM trackers. Express also has high performance overheads. Early row closure reduces the row buffer hits for workloads with good spatial locality. Furthermore, tuning the RH solution to a lower threshold (T*) increases the rate of mitigation and the associated penalty. Express also has high storage overheads. If the tracking operation is based on counters, the number of tracking entries increases due to the reduction in threshold from TRH to T*. Express is also Incompatible with in-DRAM Trackers. ExPress is a memory controller-based solution, as it may limit tON to tMRO. Therefore, ExPress is incompatible with the in-DRAM Rowhammer system and method that are unaware of the tMRO value, unless JEDEC specifications are revised to standardize tMRO.

### Additional Discussion

ImPress-P is the first RH tracker that can tolerate both Rowhammer and Row-Press. ImPress can convert the row-open time into equivalent activity for Rowhammer. Previous studies, e.g., ProTRR [26], also suggested methods to mitigate Row-Press by increasing the counter for victims of the (aggressor) row that remains active. However, the previous studies did not provide a methodology to convert the row-open time into equivalent RH. Furthermore, systems in previous studies operated with integer-valued counters, and ImPress-N shows that such an integer-valued configuration has a higher RH threshold.

While In-DRAM Stochastic and Approximate Counting (DSAC) [11] uses time-weighted counting, DSAC [11] may experience three problems. First, the weight is a logarithmic function of time, for example, for tON=256 tRC, the weight may be approximately 8, whereas the Row-Press characterization [25] shows that the weight should be about 0.48*256=122 (15× higher). Thus, DSAC underestimates the RP damage. Second, Row-Press is ignored for the row installed in the tracker, as DSAC uses a weight of 1. Third, DSAC uses integer counter values and would experience the same problem as ImPress-N, even if the weights were accurate. DSAC can be broken with Blacksmith [12], so assessing the security of DSAC against Row-Press is impractical.

Previous studies [16], [21], [47], [40], [16], [39], [23], [30], [32] have investigated trackers to identify aggressor rows, and the exemplary device can work with any of these trackers. The study did not consider In-DRAM trackers of TRR [6], DSAC [11], and PAT [20] as these can be broken with simple patterns [6][13]. The exemplary device can operate with in-DRAM trackers, such as Mithril [18], MINT [18], ProTRR [26], and PRHT [20].

Some previous studies have also looked at alternative mitigation techniques, such as rate-limiting [45] or Dynamic row migration [34], [37], [44], [43]. Other previous studies [4], [5], [15], [19], [36] have also developed ECC and detection codes to tolerate Rowhammer. All these studies can reduce, but not eliminate, DDE errors. REGA [27] and HiRA [46] modified the DRAM module to support multiple concurrent mitigative activations.

### CONCLUSION

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1]Z. B. Aweke, S. F. Yitbarek, R. Qiao, R. Das, M. Hicks, Y. Oren, and T. Austin, “Anvil: Software-based protection against next-generation rowhammer attacks,” ACM SIGPLAN Notices, vol. 51, no. 4, pp. 743-755, 2016.
[2]M. V. Beigi, Y. Cao, S. Gurumurthi, C. Recchia, A. Walton, and V. Sridharan, “A systematic study of ddr4 dram faults in the field,” in 2023 IEEE International Symposium on High-Performance Computer Architecture (HPCA), 2023.
[3]T. Bennett, S. Saroiu, A. Wolman, and L. Cojocar, “Panopticon: A complete in-dram rowhammer mitigation,” in Workshop on DRAM Security (DRAMSec), 2021.
[4]L. Cojocar, K. Razavi, C. Giuffrida, and H. Bos, “Exploiting correcting codes: On the effectiveness of ecc memory against rowhammer attacks,” in 2019 IEEE Symposium on Security and Privacy (SP). IEEE, 2019, pp. 55-71.
[5]A. Fakhrzadehgan, Y. N. Patt, P. J. Nair, and M. K. Qureshi, “Safeguard: Reducing the security risk from row-hammer via low-cost integrity protection,” in 2022 IEEE International Symposium on High Performance Computer Architecture (HPCA). IEEE, 2022.
[6]P. Frigo, E. Vannacc, H. Hassan, V. Van Der Veen, O. Mutlu, C. Giuffrida, H. Bos, and K. Razavi, “TRRespass: Exploiting the many sides of target row refresh,” in 2020 IEEE Symposium on Security and Privacy (SP). IEEE, 2020, pp. 747-762.
[7]N. Gober, G. Chacon, L. Wang, P. V. Gratz, D. A. Jimenez, E. Teran, S. Pugsley, and J. Kim, “The championship simulator: Architectural simulation for education and competition,” arXiv preprint arXiv:2210.14324, 2022.
[8]D. Gruss, M. Lipp, M. Schwarz, D. Genkin, J. Juffinger, S. O'Connell, W. Schoechl, and Y. Yarom, “Another flip in the wall of rowhammer defenses,” in 2018 IEEE Symposium on Security and Privacy (SP). IEEE, 2018, pp. 245-261.
[9]D. Gruss, C. Maurice, and S. Mangard, “Rowhammer.js: A remote software-induced fault attack in javascript,” in Detection of Intrusions and Malware, and Vulnerability Assessment, J. Caballero, U. Zurutuza, and R. J. Rodr'iguez, Eds. Chain: Springer International Publishing, 2016, pp. 300-321.
[10]H. Hassan, Y. C. Tugrul, J. S. Kim, V. Van der Veen, K. Razavi, and O. Mutlu, “Uncovering in-dram rowhammer protection mechanisms: A new methodology, custom rowhammer patterns, and implications,” in MICRO-54: 54th Annual IEEE/ACM International Symposium on Microarchitecture, 2021, pp. 1198-1213.
[11]S. Hong, D. Kim, J. Lee, R. Oh, C. Yoo, S. Hwang, and J. Lee, “Dsac: Low-cost rowhammer mitigation using in-dram stochastic and approximate counting algorithm,” arXiv preprint arXiv:2302.03591, 2023.
[12]A. Jaleel, S. W. Keckler, and G. Saileshwar, “Probabilistic tracker management policies for low-cost and scalable rowhammer mitigation,” arXiv:2404.16256, 2024.
[13]P. Jattke, V. van der Veen, P. Frigo, S. Gunter, and K. Razavi, “BLACKSMITH: Rowhammering in the Frequency Domain,” in 43rd IEEE Symposium on Security and Privacy '22 (Oakland), 2022, https://comsec.ethz.ch/wp-content/files/blacksmith sp22.pdf.
[14] JEDEC, “Jesd79-5c ddr5 sdram standard,” April 2024.
[15]J. Juffinger, L. Lamster, A. Kogler, M. Eichlseder, M. Lipp, and D. Gruss, “Csi: Rowhammer-cryptographic security and integrity against rowhammer,” in 2023 IEEE Symposium on Security and Privacy (SP). IEEE Computer Society, 2022, pp. 236-252.
[16]D.-H. Kim, P. J. Nair, and M. K. Qureshi, “Architectural support for mitigating row hammering in dram memories,” IEEE CAL, vol. 14, no. 1, pp. 9-12, 2014.
[17]J. S. Kim, M. Patel, A. G. Yaglikci, H. Hassan, R. Azizi, L. Orosa, and O. Mutlu, “Revisiting rowhammer: An experimental analysis of modern dram devices and mitigation techniques,” in ISCA. IEEE, 2020, pp. 638-651.
[18]M. J. Kim, J. Park, Y. Park, W. Doh, N. Kim, T. J. Ham, J. W. Lee, and J. H. Ahn, “Mithril: Cooperative row hammer protection on commodity dram leveraging managed refresh,” in 2022 IEEE International Symposium on High-Performance Computer Architecture (HPCA). IEEE, 2022, pp. 1156-1169.
[19]M. J. Kim, M. Wi, J. Park, S. Ko, J. Choi, H. Nam, N. S. Kim, J. H. Ahn, and E. Lee, “How to kill the second bird with one ecc: The pursuit of row hammer resilient dram,” in 56th Annual IEEE/ACM International Symposium on Microarchitecture (MICRO), 2023.
[20]W. Kim, C. Jung, S. Yoo, D. Hong, J. Hwang, J. Yoon, O. Jung, J. Choi, S. Hyun, M. Kang, S. Lee, D. Kim, S. Ku, D. Choi, N. Joo, S. Yoon, J. Noh, B. Go, C. Kim, S. Hwang, M. Hwang, S.-M. Yi, H. Kim, S. Heo, Y. Jang, K. Jang, S. Chu, Y. Oh, K. Kim, J. Kim, S. Kim, J. Hwang, S. Park, J. Lee, I. Jeong, J. Cho, and J. Kim, “A 1.Iv 16gb ddr5 dram with probabilistic-aggressor tracking, refresh-management functionality, per-row hammer tracking, a multi-step precharge, and core-bias modulation for security and reliability enhancement,” in 2023 IEEE International Solid-State Circuits Conference (ISSCC), 2023, pp. 1-3.
[21]Y. Kim, R. Daly, J. Kim, C. Fallin, J. H. Lee, D. Lee, C. Wilkerson, K. Lai, and O. Mutlu, “Flipping bits in memory without accessing them: An experimental study of dram disturbance errors,” ISCA, 2014.
[22]A. Kwong, D. Genkin, D. Gruss, and Y. Yarom, “Rambleed: Reading bits in memory without accessing them,” in 2020 IEEE Symposium on Security and Privacy (SP). IEEE, 2020, pp. 695-711.
[23]E. Lee, I. Kang, S. Lee, G. E. Suh, and J. H. Ahn, “TWiCe: preventing row-hammering by exploiting time window counters,” in ISCA, 2019.
[24]S. Li, Z. Yang, D. Reddy, A. Srivastava, and B. L. Jacob, “DRAMsim3: A Cycle-Accurate, Thermal-Capable DRAM Simulator,” IEEE Comput. Archit. Lett., vol. 19, no. 2, pp. 110-113, 2020.
[25]H. Luo, A. Olgun, A. G. Yaglikci, Y. C. Tu grul, S. Rhyner, M. B. Cavlak, J. Lindegger, M. Sadrosadati, and O. Mutlu, “Rowpress: Amplifying read disturbance in modern dram chips,” in Proceedings of the 50th Annual International Symposium on Computer Architecture, ser. ISCA '23. New York, NY, USA: Association for Computing Machinery, 2023. [Online]. Available: https://doi.org/10.1145/3579371.3589063
[26]M. Marazzi, P. Jattke, F. Solt, and K. Razavi, “Protrr: Principled yet optimal in-dram target row refresh,” in IEEE Symposium on Security and Privacy (SP). IEEE, 2022, pp. 735-753.
[27]M. Marazzi, F. Solt, P. Jattke, K. Takashi, and K. Razavi, “REGA: Scalable Rowhammer Mitigation with Refresh-Generating Activations,” in IEEE Symposium on Security and Privacy (SP). IEEE, 2023.
[28]J. D. McCalpin, “Memory Bandwidth and Machine Balance in Current High Performance Computers,” IEEE Computer Society Technical Committee on Computer Architecture (TCCA) Newsletter, 1995.
[29]A. Olgun, Y. C. Tugrul, N. Bostanci, I. E. Yuksel, H. Luo, S. Rhyner, A. G. Yaglikci, G. F. Oliveira, and O. Mutlu, “Abacus: All-bank activation counters for scalable and low overhead rowhammer mitigation,” arXiv preprint arXiv:2310.09977, 2024.
[30]Y. Park, W. Kwon, E. Lee, T. J. Ham, J. H. Ahn, and J. W. Lee, “Graphene: Strong yet lightweight row hammer protection,” in MICRO. IEEE, 2020, pp. 1-13.
[31]M. Qureshi, S. Qazi, and A. Jaleel, “Mint: Mint: Securely mitigating rowhammer with a minimalist in-dram tracker,” in 2024 57th Annual IEEE/ACM International Symposium on Microarchitecture (MICRO), 2024.
[32]M. Qureshi, A. Rohan, G. Saileshwar, and P. J. Nair, “Hydra: enabling low-overhead mitigation of row-hammer at ultra-low thresholds via hybrid tracking,” in Proceedings of the 49th Annual International Symposium on Computer Architecture, 2022, pp. 699-710.
[33]K. Razavi, B. Gras, E. Bosman, B. Preneel, C. Giuffrida, and H. Bos, “Flip feng shui: Hammering a needle in the software stack,” in 25th USENIX Security Symposium (USENIX Security 16), 2016, pp. 1-18.
[34]G. Saileshwar, B. Wang, M. Qureshi, and P. J. Nair, “Randomized rowswap: mitigating row hammer by breaking spatial correlation between aggressor and victim rows,” in Proceedings of the 27th ACM International Conference on Architectural Support for Programming Languages and Operating Systems, 2022, pp. 1056-1069.
[35]A. Saxena and M. Qureshi, “Start: Scalable tracking for any rowhammer threshold,” in 2024 IEEE International Symposium on High-Performance Computer Architecture (HPCA). IEEE, 2024, pp. 578-592.
[36]A. Saxena, G. Saileshwar, J. Juffinger, A. Kogler, D. Gruss, and M. Qureshi, “Pt-guard: Integrity-protected page tables to defend against breakthrough rowhammer attacks,” in IEEE/IFIP International Conference on Dependable Systems and Networks (DSN), 2023.
[37]A. Saxena, G. Saileshwar, P. J. Nair, and M. Qureshi, “Aqua: Scalable rowhammer mitigation by quarantining aggressor rows at runtime,” in 2022 55th IEEE/ACM International Symposium on Microarchitecture (MICRO). IEEE, 2022, pp. 108-123.
[38]M. Seaborn and T. Dullien, “Exploiting the DRAM rowhammer bug to gain kernel privileges,” Black Hat, vol. 15, p. 71, 2015.
[39]S. M. Seyedzadeh, A. K. Jones, and R. Melhem, “Mitigating wordline crosstalk using adaptive trees of counters,” in 2018 ACM/IEEE 45th Annual International Symposium on Computer Architecture (ISCA). IEEE, 2018, pp. 612-623.
[40]M. Son, H. Park, J. Ahn, and S. Yoo, “Making dram stronger against row hammering,” in Proceedings of the 54th Annual Design Automation Conference 2017, 2017, pp. 1-6.
[41]“SPEC CPU2017 Benchmark Suite,” Standard Performance Evaluation Corporation. [Online]. Available: http://www.spec.org/cpu2017/
[42]V. van der Veen, Y. Fratantonio, M. Lindorfer, D. Gruss, C. Maurice, G. Vigna, H. Bos, K. Razavi, and C. Giuffrida, “Drammer: Deterministic rowhammer attacks on mobile platforms,” in Proceedings of the 2016 ACM SIGSAC Conference on Computer and Communications Security, ser. CCS '16, New York, NY, USA, 2016, p. 1675-1689. [Online]. Available: https://doi.org/10.1145/2976749.2978406
[43]M. Wi, J. Park, S. Ko, M. J. Kim, N. S. Kim, E. Lee, and J. H. Ahn, “SHADOW: Preventing Row Hammer in DRAM with IntraSubarray Row Shuffling,” in 2023 IEEE International Symposium on High-Performance Computer Architecture (HPCA). IEEE, 2023, pp. 333-346.
[44]J. Woo, G. Saileshwar, and P. J. Nair, “Scalable and secure row-swap: Efficient and safe row hammer mitigation in memory systems,” in 2023 IEEE International Symposium on High-Performance Computer Architecture (HPCA). IEEE, 2023, pp. 374-389.
[45]A. G. Yaglikc,i, M. Patel, J. S. Kim, R. Azizi, A. Olgun, L. Orosa, H. Hassan, J. Park, K. Kanellopoulos, T. Shahroodi et al., “Blockhammer: Preventing rowhammer at low cost by blacklisting rapidlyaccessed dram rows,” in 2021 IEEE International Symposium on HighPerformance Computer Architecture (HPCA). IEEE, 2021, pp. 345-358.
[46]A. G. Yaglikc,i, A. Olgun, M. Patel, H. Luo, H. Hassan, L. Orosa, O. Er-gin, and O. Mutlu, “Hira: Hidden row activation for reducing refresh latency of off-the-shelf dram chips,” in 55th IEEE/ACM International Symposium on Microarchitecture (MICRO), 2022.
[47]J. M. You and J.-S. Yang, “Mrloc: Mitigating row-hammering based on memory locality,” in 2019 56th ACM/IEEE Design Automation Conference (DAC). IEEE, 2019, pp. 1-6.

What is claimed:

1. A dynamic random-access memory (DRAM) device configured with a data-disturbance error mitigation circuit in a dynamic random-access memory array, the device comprising:
a plurality of memory rows in a plurality of banks; and
a controller, operatively coupled to the DRAM array, configured to write, read, and refresh elements of the DRAM array, the controller being further configured to:
count, via a circuit, activation count of each memory row or a subset of memory rows in the plurality of memory rows in a unit time for a given bank;
increment activation count upon detecting, via the circuit, a defective memory row being opened for a pre-determined time period; and
refresh an adjacent memory row upon the activation count being above a specified Rowhammer threshold (TRH),
wherein the activation count accounts for both Rowhammer and Row-press net effect to mitigate the defective memory row from repeated activation (Rowhammer) or leak charge on bit lines from being opened over time (Row-press).

2. The device of claim 1, wherein the circuit to detect the defective memory row being opened for a pre-determined time period is configured to:
count, via a timer register, row open time from a starting time when a memory row is open to a stopping time when the memory row is closed over a fixed-length time window; and
increment an integer value to the activation count upon the counted row open time being at least a pre-defined minimum time a row must be kept open.

3. The device of claim 1, wherein the controller includes a counter for each bank and a timer register for each row of the plurality of banks.

4. The device of claim 1, wherein the controller includes a counter for each bank and a timer register for a subset of rows of the plurality of banks.

5. The device of claim 1, wherein the circuit to identify the defective memory row is configured to:
count, via a timer register, row open time from a starting time when a memory row is open to a stopping time when the memory row is closed over a fixed-length time window; and
increment a fractional non-integer value to the activation count upon the counted row open time being at least a pre-defined minimum time a row must be kept open.

6. The device of claim 1, wherein the controller is a memory controller.

7. The device of claim 1, wherein the controller is an in-DRAM tracker digital logic circuit.

8. The device of claim 1, wherein the specified Rowhammer Threshold is established from a Rowhammer threshold scaled by a value for a given DDR device.

9. The device of claim 1, further comprising an error correction code (ECC) circuit or a detection circuit configured to tolerate Rowhammer.

10. A system (computer system) comprising:
a dynamic random-access memory device configured with a data-disturbance error mitigation circuit in a dynamic random-access memory array, the system comprising:
a plurality of memory rows in a plurality of banks; and
a controller, operatively coupled to the DRAM array, configured to write, read, and refresh elements of the DRAM array, the controller being further configured to:
count, via a circuit, activation count of each memory row or a subset of memory rows in the plurality of memory rows in a unit time for a given bank;
increment activation count upon detecting, via the circuit, a defective memory row being opened for a pre-determined time period; and
refresh an adjacent memory row upon the activation count being above a specified Rowhammer threshold,
wherein the activation count accounts for both Rowhammer and Row-press net effect to mitigate the defective memory row from repeated activation (Rowhammer) or leak charge on bit lines from being opened over time (Row-press).

11. The system of claim 10, wherein the circuit to detect the memory row being opened for a pre-determined time period is configured to:
count, via a timer register, row open time from a starting time when a memory row is open and stopped when the memory row is stopped over a fixed-length time window; and
increment an integer value to the activation count upon the counted row open time being at least a pre-defined minimum time a row must be kept open.

12. The system of claim 10, wherein the controller includes a counter for each bank and a timer register for each row of the plurality of banks.

13. The system of claim 10, wherein the controller includes a counter for each bank and a timer register for a subset of rows of the plurality of banks.

14. The system of claim 10, wherein the circuit to identify the defective memory row is configured to:
count, via a timer register, row open time from a starting time when a memory row is open to a stopping time when the memory row is closed over a fixed-length time window; and
increment a fractional non-integer value to the activation count upon the counted row open time being at least a pre-defined minimum time a row must be kept open.

15. The system of claim 10, wherein the controller is a memory controller.

16. The system of claim 10, wherein the controller is an in-DRAM tracker digital logic circuit.

17. A dynamic random-access memory device configured with a data-disturbance error mitigation circuit in a dynamic random-access memory array, the device comprising:
a plurality of memory rows in a plurality of banks; and
a controller, operatively coupled to the DRAM array, configured to write, read, and refresh elements of the DRAM array, the controller being further configured to:
calculate, via a circuit, a probability value of a Rowhammer event in a memory row of a bank in the plurality of banks;
count, via a timer register, row open time from a starting time when the memory row is open in the bank to a stopping time when the memory row is closed over a fixed-length time window in the bank; and
recalculate the probability value of the Rowhammer event using an output of the timer register.

18. The device of claim 17, wherein the controller calculates the probability value of the Rowhammer event asp, and wherein the recalculated probability value is p(w+1), where w is the output of the timer register.

19. The device of claim 17, wherein the controller includes a timer register for each row of the plurality of banks.

20. The device of claim 17, wherein the controller includes a timer register for a subset of rows of the plurality of banks.
